(19) United States
(12) Patent Application Publication
(10) Pub. No.: US 2015/0193325 A1
(43) Pub. Date: Jul. 9, 2015

(54) METHOD AND SYSTEM FOR DETERMINING HARDWARE LIFE EXPECTANCY AND FAILURE PREVENTION

(71) Applicant: Continuware Corporation, San Francisco, CA (US)

(72) Inventors: Stefan HARSAN-FARR, Cluj (RO); John Gage Hutchens, Rumsey, CA (US)

(21) Appl. No.: 14/665,786

(22) Filed: Mar. 23, 2015

Related U.S. Application Data
(63) Continuation of application No. PCT/RO2014/000017, filed on Jun. 6, 2014.
(60) Provisional application No. 61/836,981, filed on Jun. 19, 2013.

(51) Int. Cl. G06F 11/34; G06F 11/30

(52) U.S. Cl. CPC G06F 11/3409; G06F 11/3003

(57) ABSTRACT

A method for determining and prolonging hardware life expectancy is provided. The method includes collecting data from a hardware component in a first computational device, creating a quantitative value representing the status of the hardware component, determining a lifetime of the hardware component, and providing an alert to the first computational device based on the determined lifetime of the hardware component. A system configured to perform the above method is also provided. A method for managing a plurality of hardware devices according to a hardware life expectancy includes accessing an application programming interface (API) to obtain status information of a hardware component in a computational device is also provided. The method includes balancing a load for a plurality of redundancy units in a redundancy system and determining a backup frequency for a plurality of backup units in a backup system.

### CROSS REFERENCE TO RELATED APPLICATIONS

The present disclosure claims priority to and is a continuation of International Application No. PCT/RO2014/000017, entitled METHOD AND SYSTEM FOR DETERMINING HARDWARE LIFE EXPECTANCY AND FAILURE PREVENTION, filed on Jun. 6, 2014, by Stefan Harsan-Farr and John Gage Hutchens, the contents of which are hereby incorporated by reference in their entirety, for all purposes, and which claims the benefit of U.S. Provisional patent application No. 61/836,981, entitled “HARDWARE LIFE EXPECTANCY ESTIMATION BASED ON HISTORICAL OPERATING PARAMETER TRACKING,” by Stefan Harsan-Farr and John Gage Hutchens, filed on Jun. 19, 2013, the contents of which are hereby incorporated by reference in their entirety, for all purposes.

### BACKGROUND

1. Field

The present disclosure is generally related to methods and systems for hardware health monitoring and support based on historical data collection. More specifically, the present disclosure relates to prophylactic methods and systems for providing hardware support and maintenance, and for predicting and preventing potential hardware failures before they occur.

2. Description of Related Art

Current hardware monitoring techniques are based on instantaneous parameter values or cumulative values aggregating parameter values recorded over time. A reactive model that discards a historical record of parameter values may predict the imminent death of a hardware component too late to take meaningful preventive action. Systems based on reactive models provide warnings when one of the components is functioning outside normal parameters, or when operating parameter values reach a critical level. Some examples of parameter values reaching a critical level include temperature too high, inadequate ventilation, and the like. These parameter values can alert an administrator when a part breaks down, or is about to break down. However, systems based on reactive models are unable to account for the accumulated wear for various pieces of hardware. In other cases, when cumulative damage is not recorded, determination is simply not done, but rather estimated as an average time duration which is predetermined from factory tests. Usually when these systems report malfunction, the damage is already done. The equipment may already be broken, or in the best case about to break. This can cause great inconvenience if replacement equipment is not available (such as in the case of a holiday period, a rare or expensive part). In systems lacking information on accumulated wear of hardware components, administrators wait until one piece breaks to replace it, or have replacement components in stock for everything in order to avoid downtime.

Presently, estimation of hardware equipment lifetime is done by industry standard parameters, such as POH (Power On Hours), MTBF (Mean Time Between Failure), MTTF (Mean Time To Failure), Useful Life Period, Wear Out Period, Weibull Analysis, Accelerated Life Testing. While this data is extremely useful and is often available from the manufacturer, it can only be reliably used on its own under strict conditions, such as with hardware being operated under controlled conditions throughout its entire lifetime. This is the case of clusters of supercomputers. Accordingly, in a supercomputer cluster units are installed approximately at the same time, they operate under strictly controlled environments, and are used to full capacity throughout their lifetime. Under any other condition, when the operation mode and time is not predictable, these values become coarse frames for estimating the actual lifetime of a hardware component, because a crucial element is missing: the operating conditions, and for how long the hardware was operated. Predicting the time of death of equipment under such conditions is difficult, even with accurate manufacturer provided data. Thus, prior art techniques for addressing variable equipment hardware are substantially “reactive,” in that an action is taken after a problem occurs, such as a malfunctioning pump or engine.

Various hardware components in a computing system age differently. In the absence of accurate historical information about the degradation of each hardware component, two existing approaches are used. A first approach treats the system as a whole and changes the entire system as soon as the weakest component approaches an estimated end of life. A second approach is to treat weaker hardware components based on their lifetime estimation, and change them accordingly. This however does not circumvent the inadequacy of the prediction system and cannot take into account the actual manner in which the equipment was used. Another approach to avoid outage is to create redundancy, for example RAID (Redundant Array of Independent Disks) systems, or duplicate power supplies, wait until the component breaks and change it in a reactive approach. The downside of this approach is the associated implementation cost. Indeed, systems with built-in hardware redundancy are complicated to implement and maintain, and as a result tend to be expensive.

### SUMMARY

In a first embodiment, a computer-implemented method for determining hardware life expectancy is provided. The method includes collecting data from a hardware component in a first computational device and creating a quantitative value representing the status of the hardware component. In some embodiments the method also includes determining a lifetime of the hardware component, and providing an alert to the first computational device based on the determined lifetime of the hardware component.

In a second embodiment, a system comprising a memory circuit storing commands and a processor circuit configured to execute the commands stored in the memory circuit is provided. The processor circuit causing the system to perform a method including collecting data from a hardware component in a first computational device and creating a quantitative value representing a status of the hardware component. The method also includes determining a lifetime of the hardware component and performing a preventive operation on the hardware component.

In yet another embodiment, a non-transitory computer-readable medium storing commands is provided. When the commands are executed by a processor circuit in a computer, the processor circuit causes the computer to perform a method for managing a plurality of hardware devices according to a hardware life expectancy. The method includes accessing an application programming interface (API) to obtain status information of a hardware component in a computational device and balancing a load for a plurality of redundancy units in a redundancy system. The method also includes determining a backup frequency for a plurality of backup units in a backup system.

### BRIEF DESCRIPTION OF THE DRAWINGS

FIG. 1 illustrates a system for determining hardware life expectancy based on historical data collection, according to some embodiments.

FIG. 2 illustrates a server and a computing device coupled through a network in a system for determining hardware life expectancy, according to some embodiments.

FIG. 3A illustrates a historic data collection chart for an operating parameter, according to some embodiments.

FIG. 3B illustrates a historic data collection chart with a linear trend function, according to some embodiments.

FIG. 3C illustrates a historic data collection chart with a non-linear trend function, according to some embodiments.

FIG. 3D illustrates a parametric chart relating a parameter value to a load in a central processing unit (CPU), according to some embodiments.

FIG. 4 shows a schematic representation of a system for determining life expectancy and the connections between its components, according to some embodiments.

FIG. 5 illustrates a flowchart in a method for determining hardware life expectancy, according to some embodiments.

FIG. 6 illustrates a flowchart in a method for using a hardware life expectancy for a plurality of hardware devices, according to some embodiments.

### DETAILED DESCRIPTION

In a computational/storage Information Technology (IT) infrastructure, especially in one composed of more than a single unit, for example, but not limited to, clusters of computers or cloud infrastructures, hardware components do not age uniformly. This is a result of many factors, including the fact that hardware components in a system do not have equal operational lifetime. For example, random-access memory (RAM) is expected to live longer than a Hard disk. And a solid state drive (SSD) family Hard disk is expected to live longer than a conventional (mechanical) Hard disk. Another factor contributing to aging heterogeneity is the operational temperature of hardware components. Accordingly, operational temperature influences the life of all hardware components to various degrees, from shortening to potentially terminating them if they stay long periods in a ‘danger’ zone. Furthermore, in some embodiments different hardware components are subjected to different operational temperatures. What is needed is a system and a method for accurately predicting a lifetime of individual hardware components such that preventive action may be taken in advance of system failure. What is also needed is a system and a method to prolong the lifetime of a system of hardware components by accurately evaluating the degradation of each hardware component.

Environmental conditions such as outside temperature, ventilation, humidity and dust influence operational temperature, which in turn influences lifetime. Accordingly, environmental conditions may not equivalently impact all hardware components when environmental conditions are not uniform across the system. Another factor in the heterogeneous lifetime of hardware components is load, which is highly variable between hardware components. Load in a hardware component influences operational voltage and temperature, thus impacting the lifetime of the hardware component. In a multi-unit environment, such as a computer cluster, and especially in a cloud-like setup, aging of units is usually highly disproportionate. Some hardware components may stay idle for long periods of time and as such accumulate limited degradation, whereas other hardware components reach their end of life earlier than expected when used intensively.

Accordingly, a hardware component status is determined based on critical level values provided by a manufacturer combined with cumulative values, and adding a time dimension by considering a historical record of hardware component parameter values. Critical level values may be determined under test conditions by the manufacturer. In some embodiments, the critical level is similar to or substantially equal to a factory end of life (EOL) value. Cumulative values may be obtained from a historical record of parameter values stored within dedicated storage devices residing inside the equipment itself, or in a network server accessible to the equipment administrator. Accordingly, a system and a method as disclosed herein determine in timely fashion the life expectancy of equipment using a historical record of hardware component parameter values. Moreover, the determination of life expectancy is accurate because the method accounts for variations in the operational conditions of the equipment.

Embodiments disclosed herein quantify the degradation status of hardware components, making the result available for observation to both human and computation agents such as an Application Programming Interface (API). Determination of this life expectancy of computer hardware is accomplished by a compilation of statistical and factory information combined with accurate historical data about the actual operating parameters of specific hardware components. The historical data is acquired through specialized probe agents and stored in a centralized manner such that analysis and prediction can be formulated. Once formulated, appropriate predictions and alerts regarding the potential lifetime left in the hardware components are generated. Further, in some embodiments the probe agents use the prediction analysis to take preventive action ahead of upcoming failures in certain parts of the system. Such preventive actions include increasing a sampling rate or generating alerts.

Some embodiments of the present disclosure quantify a degradation status of individual hardware components in a computer system. Accordingly, some embodiments include monitoring and recording parameter values of the hardware component across at least a portion of the hardware component lifetime. In some embodiments, the monitoring is continuous and spans the entire lifetime of the hardware component. More specifically, some embodiments combine data aggregates directly obtained from the hardware component with statistical information available through different sources, for each hardware component. Furthermore, some embodiments provide the results to probe agents (human or computational) for inspection and response, if desired. Some embodiments further provide estimates, predictions and alerts regarding the remaining lifetime in the hardware component, enabling observing agents to prepare for possible failures in certain parts of the system. In that regard, some embodiments further provide a method to prolong the usable life of the computer system by identifying problems affecting the life expectancy of each of the hardware components in the computer system before they fail. In some embodiments, a record of the operation parameters throughout the lifetime of the equipment is maintained with the aid of a low footprint probe agent that resides on each individual operating system. A central computing system residing on a server and having access to the record of the operation parameters computes comprehensive degradation values for the hardware components. The central computing system also generates reports and alerts long before the equipment fails or is about to fail, thus leaving ample time to prepare for hardware migration, if desired. The hardware maintenance model is “prophylactic” in that it provides corrective action prior to occurrence of a loss event. Having a record of the operation parameters through at least a portion of the lifetime of the hardware components enables methods and systems as disclosed herein to formulate an accurate prediction regarding the degradation status of the hardware components.

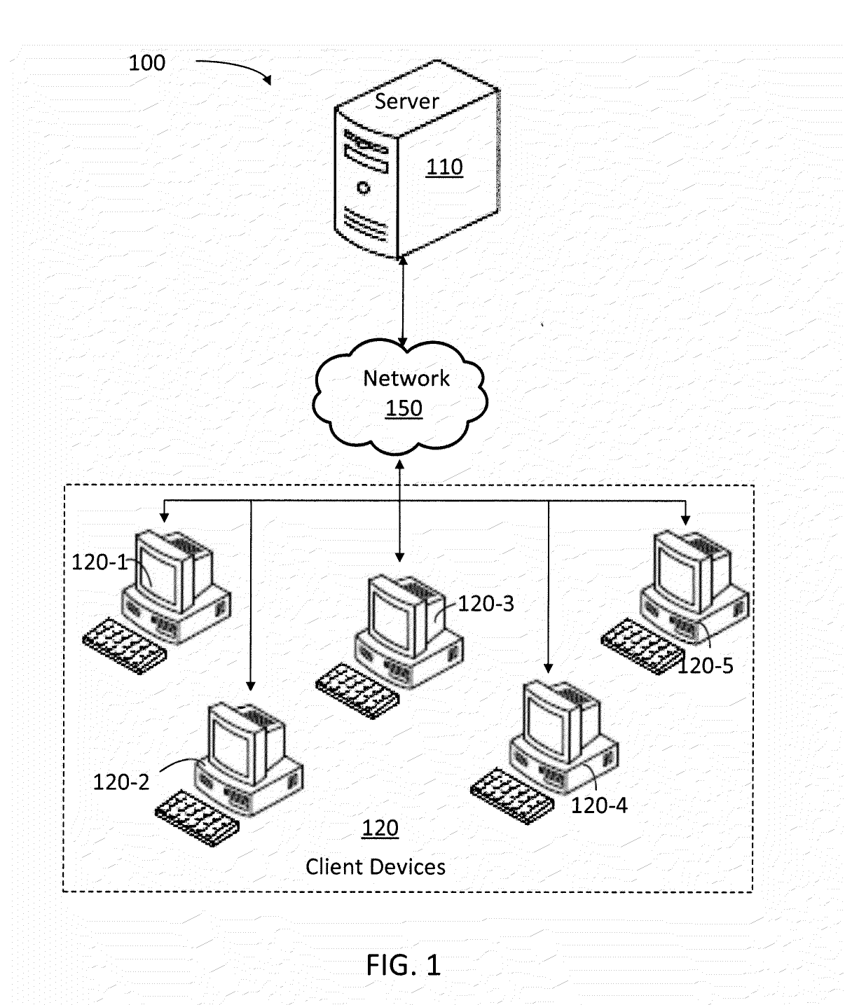

FIG. 1 illustrates a system 100 for determining hardware life expectancy based on historical data collection, according to some embodiments. System 100 includes a server 110 and client devices 120-1 through 120-5 coupled over a network 150. Each of client devices 120-1 through 120-5 (collectively referred to hereinafter as client devices 120) is configured to include a plurality of hardware components. Client devices 120 can be, for example, a tablet computer, a desktop computer, a server computer, a data storage system, or any other device having appropriate processor, memory, and communications capabilities. Server 110 can be any device having an appropriate processor, memory, and communications capability for hosting information content for display. The network 150 can include, for example, any one or more of a TCP/IP network, a personal area network (PAN), a local area network (LAN), a campus area network (CAN), a metropolitan area network (MAN), a wide area network (WAN), a broadband network (BBN), the Internet, and the like. Further, network 150 can include, but is not limited to, any one or more of the following network topologies, including a bus network, a star network, a ring network, a mesh network, a star-bus network, tree or hierarchical network, and the like.

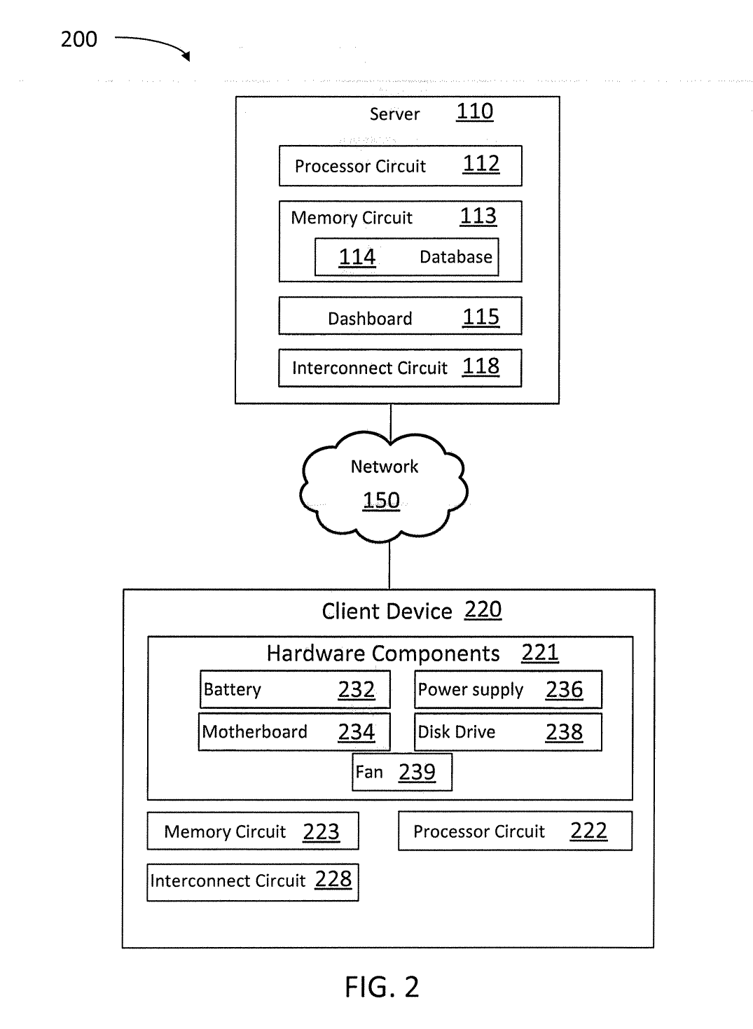

FIG. 2 illustrates a server 110 and a client device 220 coupled through network 150 in a system 200 for determining hardware life expectancy, according to some embodiments. Server 110 includes a processor circuit 112, a memory circuit 113, a dashboard 115, and an interconnect circuit 118. Processor circuit 112 is configured to execute commands stored in memory circuit 113 so that server 110 performs steps in methods consistent with the present disclosure. Interconnect circuit 118 is configured to couple server 110 with network 150, so that remote users can access server 110. Accordingly, interconnect circuit 118 can include wireless circuits and devices, such as Radio-Frequency (RF) antennas, transmitters, receivers, and transceivers. In some embodiments, interconnect circuit 118 includes an optical fiber cable, or a wire cable, configured to transmit and receive signals to and from network 150. Memory circuit 113 can also store data related to client device 220 in a database 114. For example, database 114 can include historical operation data from at least one of the plurality of hardware components. Server 110 includes a dashboard 115 to provide a graphic interface with a user for displaying information stored in database 114 and to receive input from the user.

Client device 220 includes a plurality of hardware components 221, a processor circuit 222, a memory circuit 223, and an interconnect circuit 228. In some embodiments client device 220 is a redundancy system and hardware components 221 are redundancy units. In some embodiments, client device 220 is a backup system and hardware components 221 are backup units. In that regard, the backup system may be configured to dynamically store large amounts of information from a plurality of computers forming a local area network (LAN). Accordingly, in some embodiments, client device 220 is configured to store large amounts of information for long periods of time, and provide dynamic access, read, write, and update operations to the stored information. For example, a redundancy system or a backup system can include a server computer coupled to a local area network (LAN) to service a plurality of computers in a business unit. In some embodiments hardware components 221 include a battery 232, a motherboard 234, a power supply 236, at least one disk drive 238, and at least one fan 239. More generally, hardware components 221 may include any hardware device installed in client device 220. In some embodiments, hardware components 221 include a RAID, or a plurality of memory disks configured to backup massive amounts of data. Moreover, in some embodiments hardware components 221 include a plurality of processor circuits 222 such as central processing units (CPUs). In some embodiments, hardware components 221 are configured to measure and report parameters that can influence their lifetime. For example, disk drive 238 may include hard disks having SMART (Self-Monitoring, Analysis and Reporting Technology) data including, but not limited to, values for rotation speed, temperature, spin up time, Input/Output (IO) error rate, and total time of operation. Likewise, CPUs in hardware components 221 can report load values (in percentage), voltage and operational temperature. Motherboard 234 can report operational temperatures, and voltages to server 110. Power supply 236 can report operational temperature, voltage and current values. Fan 239 can report on its speed. Each of these parameters influence degradation (e.g., wear) as a function of momentary values and time.

Within each individual client device 220, each elementary hardware component 221 has a unique identification (ID). The hardware component ID can include any or a combination of: component type, manufacturer name, manufacturer ID, serial number, or any other available information. Accordingly, the hardware component ID transcends operating system re-installation. That is, the hardware component ID is independent from a specific value used by an operating system installed in memory circuit 223 and executed by processor circuit 222. More generally, processor circuit 222 is configured to execute commands stored in memory circuit 223 so that client device 220 performs steps in methods consistent with the present disclosure. Interconnect circuit 228 is configured to couple client device 220 with network 150 and access server 110. Accordingly, interconnect circuit 228 can include wireless circuits and devices, such as Radio-Frequency (RF) antennas, transmitters, receivers, and transceivers, similarly to interconnect circuit 118 in server 110. Interconnect circuit 228 can include a plurality of RF antennas configured to couple with network 150 via a wireless communication protocol, such as cellular phone, blue-tooth, IEEE 802.11 standards (such as WiFi), or any other wireless communication protocol as known in the art.

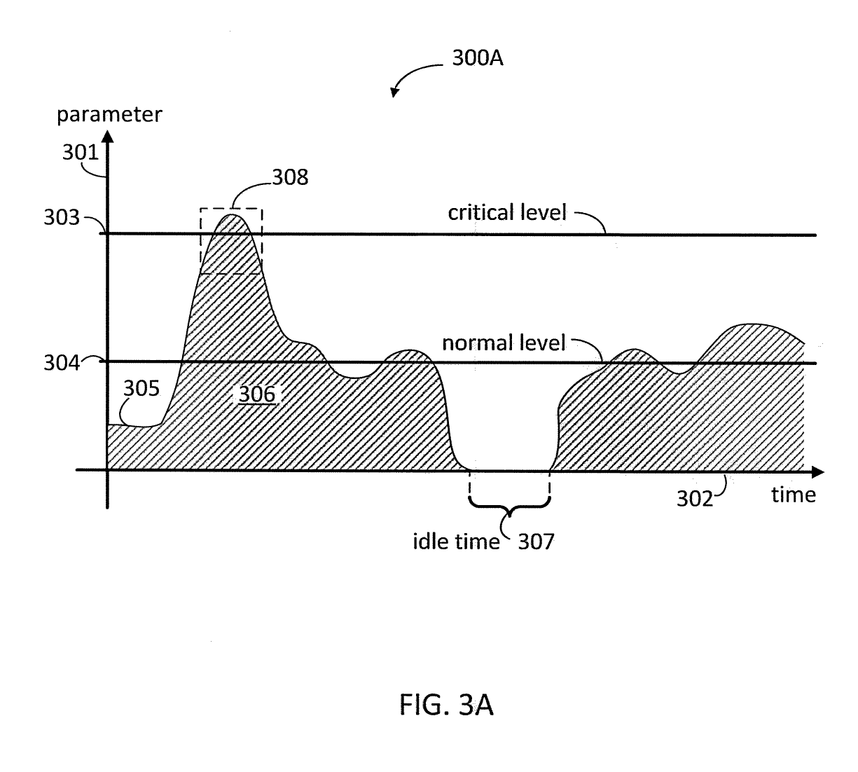

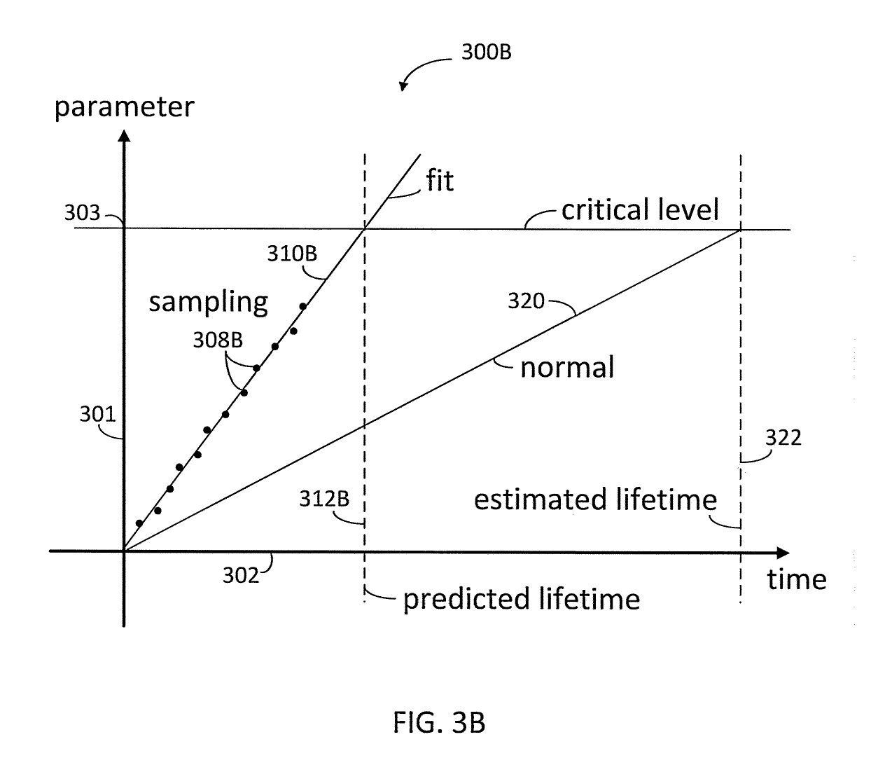

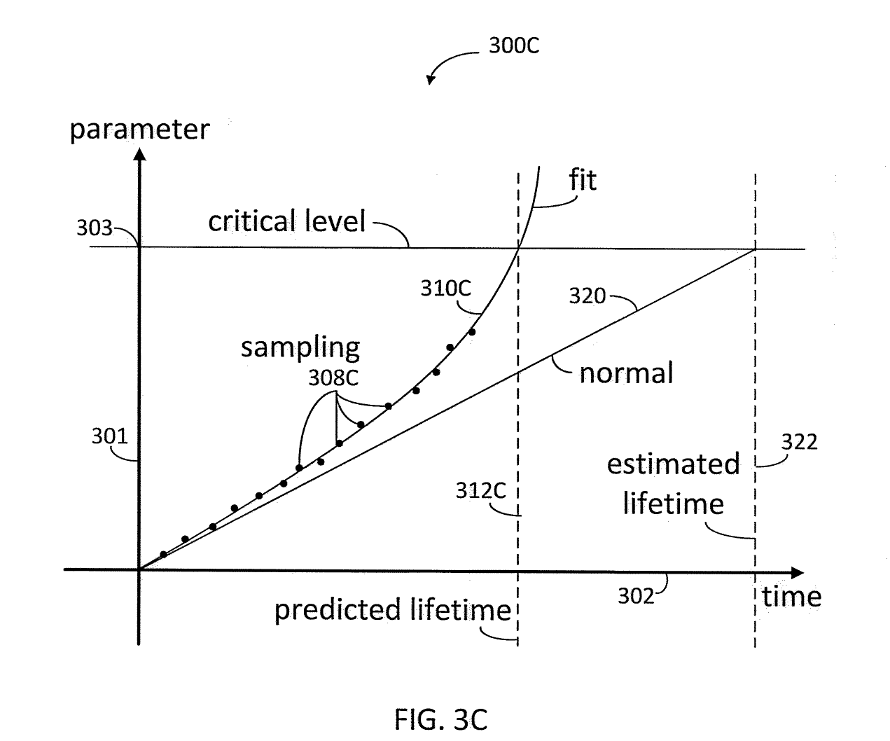

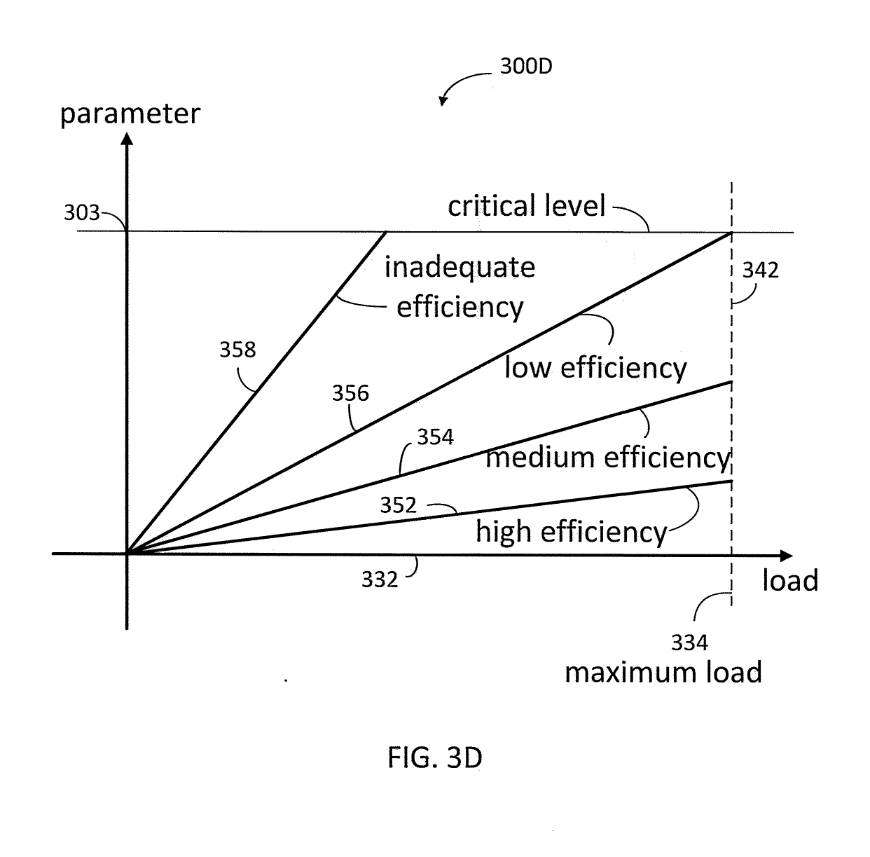

FIG. 3A illustrates a historic data collection chart 300A for an operating parameter 301, according to some embodiments. Chart 300A illustrates curve 305 having a parameter 301 in the ordinates (Y-axis), and a corresponding time value 302 in the abscissae (X-axis). It can be seen in FIG. 3A that a single value of parameter 301 provides only partial information of hardware status. Instantaneous readings of parameter value 301 highlight immediate dangerous situations. Accordingly, a Mean Time Between Failures (MTBF) or a Useful Life Period (ULP) indicate the number of hours a component can be reliable. In addition to MTBF and ULF, an accurate capture of the physical state of a hardware component to predict a failure includes recording parameter value 301 over extended periods of time, as shown in FIGS. 3A-3D.

Parameter values 301 include different parameters relevant to the hardware component operation. For example, parameter 301 may include the number of failures occurring in a writing operation of a hard disk drive. In a ‘normally’ operating system, a ‘write’ operation on a hard disk drive fails when bad sectors emerge in the medium where the memory will be stored. Other factors that relate to failure of the hardware component include fluctuations in current, unexpected voltage spikes, and other events. Such events are detected by error detection algorithms and stored in a historical record while the errors may be corrected within the hardware component itself. Whether the correction is successful or not, the event is recorded in the system (e.g., by the SMART system). The system performs dynamic recording of parameter values 301 including events such as failures and idle time, to determine and predict evolution of the hardware system with sufficient lead time for taking preventive measures. There are many parameters that can be dynamically analyzed and stored for problem anticipation. In some embodiments, a data processing of the recorded parameters may include averaging the recorded parameters having similar scope to improve the end result of the prediction. For example, usage parameters from a large group of hard disk drives using common technology may be averaged and the average value used to compare with each hard drive monitored.

Parameter 301 fluctuates around a normal functioning value 304, occasionally climbing to a dangerous value 303 or dropping to zero, when the component is not operational. In some embodiments, an integrated value 306 of parameter 301 is obtained, which provides a more accurate description of the hardware component usage and status. For instance, knowing the amount and length of idle time 307 accumulated for a particular component, it is possible to determine the amount of remaining ULF of a component. The ULF of a component is based on the mathematical subtraction between a predetermined factory estimation and the actual period of operation. Accordingly, the actual period of operation is determined by the amount of time 302 that the value of parameter 301 is different from zero. Likewise, it is statistically accurate to assume that a period of time 308 spent around critical (dangerous) values 303 affects the ULF of a component negatively. A precise account of time periods 307 and 308 provides an accurate description of the operating conditions of the hardware component. Accordingly, the operating conditions of the hardware components may be substantially different from factory given values, which are based on normal operating conditions.

FIG. 3B illustrates a historic data collection chart 300B with a linear trend function 310B, according to some embodiments. Curves 310B and 320 have parameter 301 in the ordinates (Y-axis), and time value 302 in the abscissae (X-axis), with arbitrary units. In some embodiments, parameter 301 may include a number of ‘write’ operations in a hard disk. Accordingly, critical level 303 is the number of ‘write’ operations provided by the manufacturer after which a hard disk starts losing storing capacity. More specifically, in some embodiments critical level 303 indicates an end of life (EOL) corresponding to the maximum amount of writes a hard disk supports as specified by the manufacturer. Values of critical level 303 vary between hard disks using different technologies. For example, for a hard disk using ‘Flash’ technology in a solid state drive (SSD), critical level 303 is lower than for hard disks using mechanical technologies, such as optical or magnetic data storage in a rotating medium. The number of ‘write’ operations is observed and recorded over time, forming a set of sampling data points 308B. Sampling data points 308B may be approximated by a linear fit 310B. A predicted lifetime 312B is the time when the hard disk reaches critical value 303 according to linear fit 310B.

Chart 300B includes a curve 320 indicating a ‘normal’ hard disk usage estimated by the manufacturer. Accordingly, a ‘normal’ hard disk following curve 320 reaches critical level 303 within an estimated lifetime 322. However, usage of a hard disk varies depending on its application. For example, a hard disk used for caching incurs a larger number of ‘write’ operations than a disk used for storage or backup. For example, linear fit 310B to sampling data 308B illustrates a more intensive hard disk usage than estimated by curve 320. As such, predicted lifetime 312B is shorter than estimated lifetime 322. For example, in some embodiments predicted lifetime 312B may be approximately 28 months and estimated lifetime 322 may be approximately 60 months. Chart 300B illustrates that the shortened predicted lifetime 312B is due to a higher than predicted usage pattern, and not due to malfunction or accident. Accordingly, by recording historical data as illustrated in chart 300B, a system performing methods as disclosed herein is able to distinguish between a malfunction, an accident, or a regular usage pattern for a given hardware component. Knowledge of predicted lifetime 312B avoids data loss produced when disk failure occurs earlier than estimated lifetime 322. Moreover, in some embodiments consistent with the present disclosure, preventive measures in advance of hard disk failure at predicted time 312B avoid undesirable data loss.

FIG. 3C illustrates a historic data collection chart 300C with a non-linear fit 310C, according to some embodiments. Non-linear fit 310C results from sampling data points 308C reflecting an increased usage of the hard disk over time. Chart 300C displays parameter 301 as a function of time 302, similar to charts 300A and 300B. Chart 300C includes critical level 303 for parameter 301. In chart 300C, critical level 303 is reached when a ratio of a number of write fails to the number of write commands issued attains a pre-determined value. As in chart 300B, ‘normal’ function 320 assumes a linear behavior with estimated lifetime 322 under factory provided operating parameters. As in chart 300B, factory provided operating parameters are controlled values. Non-linear fit 310C indicates a predicted lifetime 312C substantially shorter than estimated lifetime 322. Non-linear fit 310C may be a polynomial fit, an exponential fit, a sinusoidal fit, a logarithmic fit, or any combination of the above. Accordingly, the more accurate predicted lifetime 312C accounts for specific situations that may occur at the actual deployment site of the hardware component. For example, a hard disk operating under higher than ‘normal’ temperature conditions may increase degradation of the material leading to non-linear fit 310C. Regardless of the specific non-linear fit used, curve 310C predicts future evolution of the hardware component based on past values more accurately than function 320. Note that early usage of the hardware component (i.e. sampling points 308C) may closely match function 320. However, accelerated hardware component degradation may cause sampling points 308C to curve upwards along fit 310C resulting in predicted lifetime 312C. Accordingly, curve 310C allows timely application of corrective measures such as replacing the hardware component (e.g. a hard disk) or finding and correcting the cause of the accelerated degradation.

FIG. 3D illustrates a parametric chart 300D relating parameter value 301 to a CPU load 332, according to some embodiments. Accordingly, chart 300D determines distinct patterns of behavior including subtle problems that may in time lead to hardware component failure. Detecting subtle problems ahead of time enables the system to apply corrective steps before more serious problems occur. More specifically, CPU parameters such as temperature and load 332 may be related to a CPU fan speed as parameter 301. The three values are correlated, as follows. The CPU has a normal operating temperature determined by the manufacturer and maintained by a heat sink. A fan provides air flow through the heat sink. Increased CPU load in the processor increases CPU temperature. In such scenario, the system increases air flow through the heat sink with a higher fan speed. The increased air flow brings CPU temperature to the normal value. Accordingly, CPU load, CPU temperature, and fan speed form a dynamic set of parameters. In some embodiments, a transfer function is built either in the BIOS or directly into the hardware components to maintain CPU temperature at normal value. Thus, when a constant temperature is desired, different values of CPU load 332 result in different fan speeds 301, according to curves 352, 354, 356, and 358 in chart 300D. Curves 352, 354, 356, and 358 are bound by a critical level 303 given by a maximum attainable fan speed, and a CPU maximum load 334 (typically 100%). Each of curves 352, 354, 356, and 358 has a slope that determines a CPU cooling efficiency. A lower slope indicates a greater cooling efficiency, and a greater slope indicates a lower cooling efficiency.

FIG. 3D illustrates fan speed 301 responding to CPU load 334 in order to maintain the CPU at a ‘normal’ operating temperature under different cooling efficiency regimes. The more efficient the cooling the less fan speed is necessary, such as in curve 352 (high efficiency). The less efficient the cooling the more fan speed is necessary, as illustrated by curve 356 (low efficiency). A curve 354 having a slope above curve 352 and below curve 356 may correspond to a medium cooling efficiency. When cooling efficiency drops under a threshold the fan reaches maximum speed 303 before the CPU has reached maximum load 334, as shown by curve 358 (inadequate efficiency). Such an event may trigger undesirable overheating events.

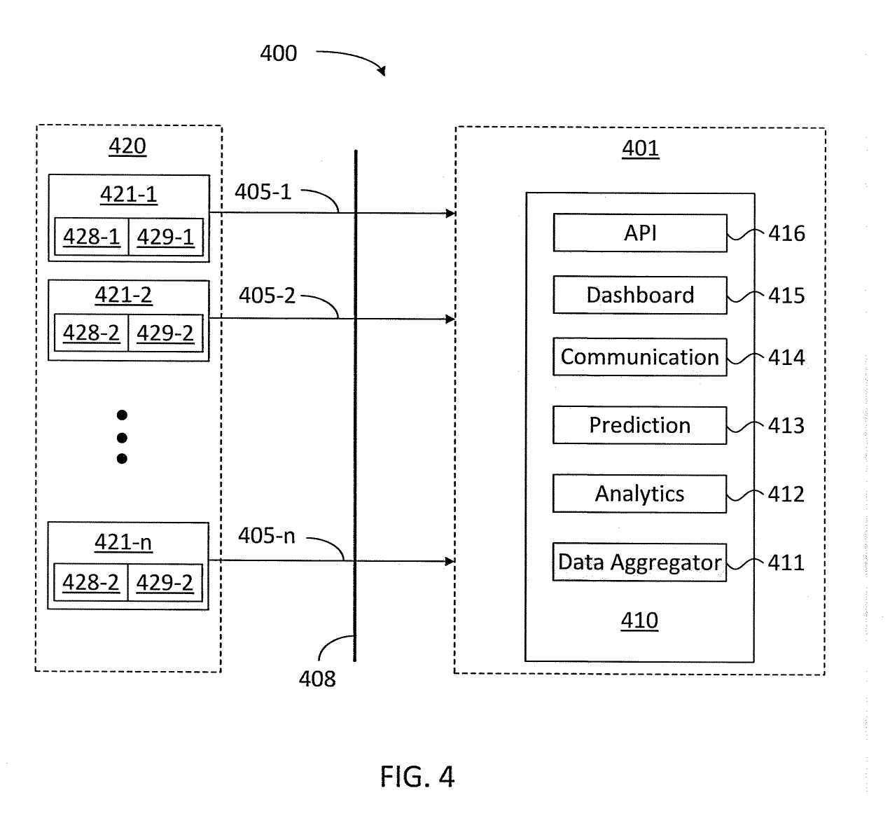

Some embodiments establish a ‘norm’ for historical hardware component tracking by aggregating multiple curves for different CPU systems (e.g., curves 352, 354, 356, and 358). Accordingly, parametric chart 300D provides a reliable indication of the cooling efficiency of the system. In some embodiments, data in parametric chart 300D is used to obtain precise information of system status. For example, the cooling efficiency of the system, as related to the slope in curves 352, 354, 356, and 358 is indicative of system status and configuration. Accordingly, a drop in cooling efficiency below a threshold may indicate that the ambient temperature is beyond a specified value. In some configurations, the cooling efficiency may be associated with an ambient humidity, an air flow blockage, and more generally with a heat exchange efficiency. Once identified, issues reducing cooling efficiency may be easily solved by adjusting the system configuration, environmental parameters, or simply shutting the system down to prevent a catastrophic failure. For example, a sudden drop in efficiency could indicate a blockage in the air flow produced by an inadequately placed accessory in front or in the back of the computer. In that regard, cables inside the computer may block air flow in the cooling system. Likewise, a gradual drop in cooling efficiency can result from a dust buildup inside the system, preventing efficient heat exchange. In some embodiments, a lower than normal value of cooling efficiency in a new system indicates an error in the build or the assembly of the system. Errors in the build of a new system may include improperly placed cables, incorrectly attached heat syncs, insufficient conductive silicone, or even a malfunctioning processor. Timely recognition of these problems can reduce damage to system components and prevention of a sudden failure by taking preventive actions. Accordingly, prophylactic models consistent with the present disclosure include statistical information and factory provided values for the hardware component as a point of comparison. A general schematic representation of a system to provide such a prophylactic model is presented in FIG. 4 described in detail below.

FIG. 4 shows a schematic representation of system 400 for determining life expectancy and the coupling between its parts, according to some embodiments. In some embodiments system 400 determines the degradation state of a hardware system 420, hereinafter referred to as “object system” 420. Object system 420 includes one or more computing units 421-1, 421-2, through 421-n (hereinafter collectively referred to as “object units” 421) without an actual predefined limit. That is, the value of ‘n’ may be any integer number, such as 5, 10, 20, or even more. Each one of object units 421 is a cohesive composite of physical hardware components, upon which an operating system can be installed. In that regard, object units 421 may include a desktop computer, a server grade computer, a mobile device, and the like. Accordingly, system 400 may be a Local Area Network (LAN) of computing units 421. Each object unit 421 is in turn composed of hardware components such as but not limited to, power supply, battery, a processor circuit (CPU), a memory (e.g., volatile memory circuit and long term storage devices, hard disks, CD ROMs, and the like), and an interconnect circuit (e.g., a communication bus). The momentary operating parameters of the hardware components can be read via open source or proprietary software libraries, such as drivers.

Alongside operating system 428-1, a software agent 429-1 is installed, which will be referred to as the “probe agent” 429-1. Probe agents 429-1 gather momentary readings of the operating parameters of the elementary hardware components and submit them to a “central system” 401 at regular time intervals. The time intervals can be predetermined or influenced by factors such as the availability of communication, network load, and the overall status of object unit 421-1.

Probe agents 429 are installed as service elements, meaning that they run in the background and are started along with the operating system. Because a certain delay will exist from the starting of the system and the start-up of the agent, the number of start-ups must be recorded because the accumulated lag is in fact a gap in the operation parameter record. While the system suffers least wear during start up (components are cold, processors are moderately loaded), a large number of start-ups can accumulate into a significant gap, which must be accounted for. Probe agents 429 identify themselves to central system 401 with a unique key that is given to probe agents 429 at first installation. This unique key can also be computed via hardware fingerprinting. The key is desirably transparent to changes in hardware. It is also desirable that the key be unique and consistent across the life of an object unit. While communication may not transmit sensitive and proprietary information about local machines and as such communication can be done via unsecured channel, in some embodiments, it is desirable that the communication be encrypted for general security reasons. A Public/Private key encryption system ensures a secure communication channel. Additionally, the key uniquely identifies the hardware component because of matching public and private keys according to encryption.

Probe agents 429 are connected to central system 401 via a communication layer 408 including a network (e.g., network 150). Communication layer 408 includes channels 405-1, 405-2, through 405-n and can reside on one of the computers of the object system, or separated from it by a local area network or by a wide area network such as the internet. Probe agents 429 use communication layer 408 to submit the collected data to the central system, individually or collectively, via one of probe agents 429. In the collected data, probe agents 429 include the serial number of the hardware components in probe object units 421. If a serial number for a hardware component cannot be computed, probe agent 429 generates one automatically. In such a case, the operator coordinating the migration of probe agent 429 to a new operating system 428 (on the same object unit 421) ensures consistent identification of the hardware components through the transition. In some embodiments, when a new ID is generated for a hardware component that is being replaced, the operator marks the replacement of the hardware component in the central system 401.

In embodiments using automatically identifiable hardware components, probe agent 429 detects the disappearance of a hardware component or the appearance of a new one. In some embodiments probe agent 429 infers that a replacement of a given hardware component has taken place when the new component performs the same function as the old one. In some embodiments the operator confirms the replacement of the hardware component in central system 401. With each packet of data bearing the identification of probe agent 429, central system 401 is aware of the presence of probe agent 429 and the hardware component associate with it. When probe agent 429 fails to transmit data to central system 401, central system 401 recognizes that probe agent 429 is down. Probe agent 429 may be down due to a variety of reasons: the agent itself broke, the hardware component associated with the probe agent is broken, or is deliberately stopped. Or due to the communication between probe agent 429 and central system 401 is interrupted. Central system 401 issues an alert and the operator decides upon the correct course of action. To mitigate some of the problems presented by manual shutdown and start-up of some object units 421, for instance when less or more computation power is needed for maintenance reasons, an automated control system can be built into probe agents 429 and central system 401. Automated shut down is possible for all operating systems via system libraries, therefore probe agents 429 can be programmed to issue a shut-down command in an automated manner, such as a trigger from central system 401. If shut down happens this way, central system 401 no longer needs to guess whether the lack of communication is a result of manual shut down (in which case there degradation is not accumulating) or lack of communication, agent malfunction, etc. (in which case, degradation does accumulate, only it is not being tracked).

Similarly, hardware components supporting “Wake on LAN” or “Integrated Lights Out (ILO)” technologies, can be started in an automated manner from central system 401 without manual intervention. If such remote control is not desirable for security reasons, a peer-to-peer communication system between probe agents 429 may be implemented. In such configuration probe agents 429 are aware of other probe agents 429 within object system 420, with or without them being powered up. Such configuration can solve a start-up issue for all but one initial probe agent. In this situation, a limited manual interaction may be combined with partial automation so that in continuously running platforms the amount of manual intervention is reduced. This may be the case when at least one hardware element is operational for extended periods of time.

Continuing to refer to FIG. 4, central system 401 includes a series of components separated into individual software modules. In some embodiments, components in central system 401 may be clustered together in one or more larger modules, such as in a server 410. Collectively, these modules are responsible for aggregating the data, storing it throughout the individual lifetime of an elementary hardware component, processing the data, continuously observing it and generating alerts for a human or computer operator. These activities are based on the accumulated data aggregate and available statistical information, which is continuously updated.

A data aggregator module 411 is responsible for collecting the information, compressing it if necessary, storing it into the database and making it available as desired. The analytics module 412 is responsible for creating comprehensive quantitative values representing the degradation status of each elementary hardware component, each object unit 421 as a system of hardware components, and object system 420 as a whole. Analytics module 412 calculates values substantially the same as (in terms of measurement unit), or comparable to the statistical values available in the field from the hardware vendor, or computed internally as statistically relevant limit values, over time. For example, a fan may be designed for a certain number of revolutions over its lifetime. While the momentary rotation speed of a fan may not reflect a degradation status of the fan, by recording the rotation speed over time it is possible to calculate the number of revolutions that the fan accumulated since being placed in service. From this aggregated data, it is possible to estimate the degree to which the fan approaches its end of life (EOL).

In some embodiments, analytics module 412 includes statistical information available in the market (e.g., through manufacturers of hardware components). When the information is not available, analytics module 412 formulates common sense rules about the state of degradation of various components. For example, some hard drive manufacturers do not specify how many rotations a disk drive may perform within its lifetime. However, it is known that a disk drive operating at 35 degrees Celsius has a lifetime twice as long as on as a disk drive that operates at 70 degrees Celsius. It is also known that the degradation of magnetically stored information is not only a factor of operation but also of time, whether the disk drive is in service or not. Furthermore, the degradation of magnetically stored information is also influenced by operating temperature. Based on available empirical values as above, analytics module 412 computes degradation scores of hard disk drives. Likewise, analytics module 412 computes degradation scores for other hardware components in object system 420. When the degradation state of the hardware components is known, estimations and averages can be made about the degradation state of object system 420 as a whole.

A prediction module 413 compares the computed values, usage patterns and the available statistical values in the industry to determine when a certain hardware component will reach its end of life. Prediction module 413 includes usage patterns as well as values directly influencing degradation, such as temperature and other environmental conditions. For example, a disk drive that operates at 60 degrees Celsius for eight (8) hours a day and sits idle for the rest will have a longer life than a disk drive operating at the same temperature for twenty four (24) hours a day, even though they may be placed in operation at similar times and be the same make and model. A communication layer 414 provides notifications about alerts provided by prediction module 413. The notifications are transferred to the appropriate handler by any medium such as, but not limited to, email, SMS, and the like, so that action can be taken. In some embodiments, communication layer 414 provides notifications to a dashboard module 415. Dashboard module 415 can be interrogated by human operators directly to obtain up to date, comprehensive reporting regarding the health/degradation status of object system 420. API layer 416 provides insight to other computational devices about the degradation state of object system 420. Accordingly, API layer 416 allows other computational devices to automatically take corrective or preventive action. For example, object system 420 may include a redundancy system querying central system 401 via API 416. The redundancy system then determines a status of the hardware components 421. As a consequence, the redundancy system can decide to balance the load in the redundancy units, such that each redundancy unit contains at least one hardware component accumulating comparatively lower degradation. In this way, system 400 reduces the possibility of losing data in an eventual cascading failure of a hardware component approaching its estimated lifetime. In some embodiments, object system 420 includes a backup system automatically determining the frequency of a backup operation based on the age of the equipment and the rate of accumulation of degradation.

Accordingly, central system 401 performs life expectancy prediction using historical operating parameters. To enhance prediction accuracy, central system 401 controls parameters such as continuity of sampling and rate of sampling. In that regard, it is desirable that the historical data be as complete as possible. In some embodiments central system 401 starts recording data close to or even precisely at the time of placing object system 420 in operation, continuing without interruption throughout the lifetime of the hardware in object system 420. Reducing monitoring interruptions enhances the accuracy of prediction. In that regard, when object system 420 includes second hand hardware components, it is desirable to incorporate into central system 401 a registered record for the second hand hardware component. When sampling is performed frequently, the track record may include values that are relevant to the degradation history (e.g., idle period 307 and period of time 308). The variation of hardware operation parameters sometimes is fast and in some cases a time period may not be sampled. To cover time periods with no sampling, central system 401 performs interpolation to determine intermediate values, which may be relatively accurate in case of high latency values like temperature. In case of rapidly changing values like a CPU load, central system 401 may rely on faster sampling, avoiding large periods of time with no sampling.

Central system 401 is configured to respond to unexpected events and accidents. The values provided by central system 401 are based on empirical and statistical information. Accordingly, values provided by central system 401 typically follow the rule of averages of large numbers. However, in some instances an unexpected failure occurs among the components of object system 420. In such an event, the handling of the problem will simply fall back to a reactive method. In some instances a hardware component whose lifetime has been predicted to have come to an end may continue to run for a certain amount of time. In such scenario a cost-risk analysis may determine to continue utilization of such hardware component, or the cost-risk analysis may determine to replace the hardware component even when the hardware continues to operate. The monitoring of operational parameters by central system 401 continues regardless of the decision to continue using or replacing the hardware equipment. A subclass of unexpected events includes accidents such as but not limited to: mechanical shock, water contamination, power surge, and the like. Prediction of accidental failures may include the use of more sophisticated sensors such as accelerometers and fast power monitoring devices.

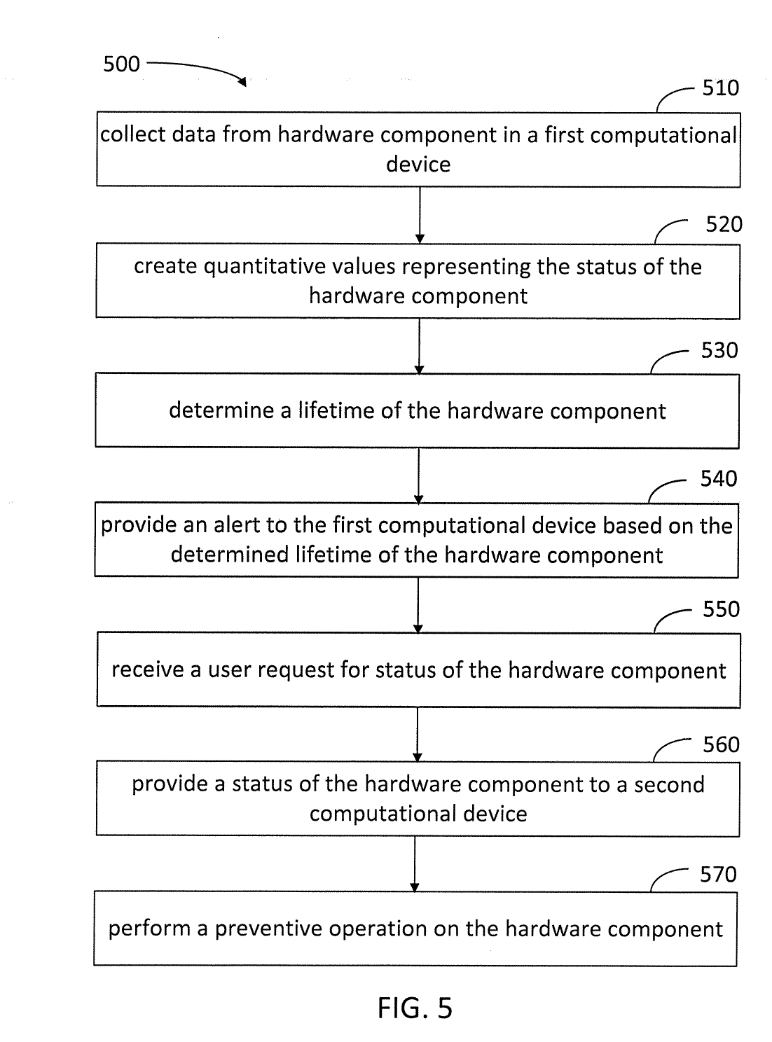

FIG. 5 illustrates a flowchart in a method 500 for determining hardware life expectancy, according to some embodiments. Steps in method 500 can be performed by a processor circuit in a computer, the processor circuit executing commands stored in a memory circuit of the computer. Accordingly, steps in method 500 can be partially or completely performed by processor circuit 112 in server 110 and processor circuit 222 in client device 220. In some embodiments of method 500, the computer is a server, and the memory circuit includes a database with information related to at least one hardware component from a plurality of hardware components (e.g., server 110, database 114, and hardware components 221). Embodiments consistent with method 500 include at least one of the steps illustrated in FIG. 5, performed in any order. Furthermore, in some embodiments consistent with method 500, steps illustrated in FIG. 5 are performed simultaneously in time, or approximately simultaneously in time. Accordingly, in some embodiments consistent with method 500, steps in FIG. 5 are performed at least partially overlapping in time. Moreover, in some embodiments consistent with method 500, other steps can be included in addition to at least one of the steps illustrated in FIG. 5.

Step 510 includes collecting data from the hardware component in a first computational device. Step 520 includes creating a quantitative value representing the status of the hardware component. Step 530 includes determining a lifetime of the at least one of the hardware component. Step 540 includes providing an alert to the first computational device based on the determined lifetime of the hardware component. Step 550 includes receiving a user request for status of the hardware component. Step 560 includes providing a status of the hardware component to a second computational device. And step 570 includes performing a preventive operation on the hardware component in view of the predicted lifetime of the hardware component. Accordingly, in some embodiments step 570 includes replacing the hardware component altogether with a new hardware component. In some embodiments step 570 includes rearranging a hardware configuration in the first computational device, such as removing cables, cleaning accumulated dust inside the computational device, or moving the computational device to a different location to increase a cooling efficiency for the hardware component.

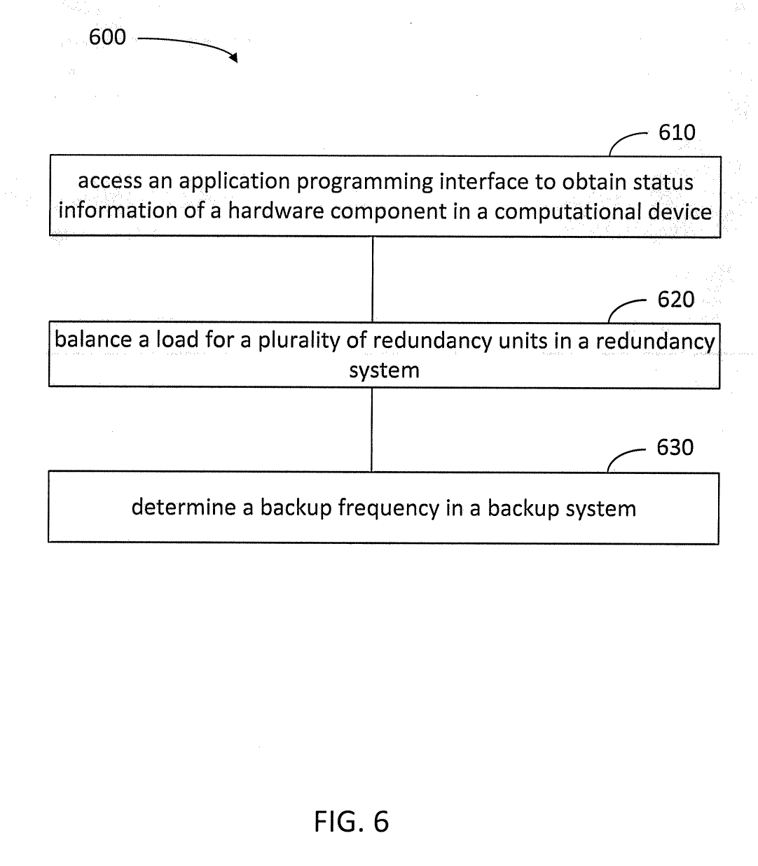

FIG. 6 illustrates a flowchart in a method 600 for using a hardware life expectancy for a plurality of hardware devices, according to some embodiments. Steps in method 600 can be performed by a processor circuit in a computer, the processor circuit executing commands stored in a memory circuit of the computer. Accordingly, steps in method 600 can be partially or completely performed by processor circuit 112 in server 110 and processor circuit 222 in client device 220. In some embodiments of method 600, the computer is a server, and the memory circuit includes a database with information related to at least one from a plurality of hardware components (e.g., server 110, database 114, and hardware components 221). In some embodiments, steps consistent with method 600 may be at least partially performed by a redundancy system including a plurality of redundancy units, the redundancy system being an object system as described herein and at least one of the redundancy units includes a hardware component as described herein (e.g., object system 420 and hardware components 421). Further according to some embodiments, steps consistent with method 600 may be at least partially performed by a backup system including a plurality of backup units, the backup system being an object system as described herein and at least one of the backup units includes a hardware component as described herein (e.g., object system 420 and hardware components 421). Embodiments consistent with method 600 include at least one of the steps illustrated in FIG. 6, performed in any order. Furthermore, in some embodiments consistent with method 600, steps illustrated in FIG. 6 are performed simultaneously in time, or approximately simultaneously in time. Accordingly, in some embodiments consistent with method 600, steps in FIG. 6 are performed at least partially overlapping in time. Moreover, in some embodiments consistent with method 600, other steps can be included in addition to at least one of the steps illustrated in FIG. 6.

Step 610 includes accessing an application programming interface to obtain status information of a hardware component in a computational device. Step 620 includes balancing a plurality of redundancy units in a redundancy system. In some embodiments, step 620 includes reducing the load on a first redundancy unit when a lifetime expectancy of the redundancy unit is lower than a lifetime expectancy on a second redundancy unit. In some embodiments, step 620 includes reducing the load on a redundancy unit when the lifetime expectancy of the redundancy unit is lower than a mean lifetime expectancy. Accordingly, the mean life expectancy is a value provided by the manufacturer. In some embodiments, the mean lifetime expectancy is an average of historically collected life expectancies for similar redundancy units. Step 630 includes determining a backup frequency in a backup system. In some embodiments, step 630 includes increasing the backup frequency in a first backup unit when a lifetime expectancy of the first backup unit is lower than a lifetime expectancy of a second backup unit. In some embodiments, steps in method 600 may be included in a method to prolong the usable life of a hardware system (e.g., hardware system 420) by identifying problems affecting life expectancy of each of the hardware components in the hardware system. In some embodiments, at least one of steps 610 and 620 may be included as part of step 570 for performing a preventive operation on the hardware component.

Methods 500 and 600 are embodiments of a more general concept including continuous monitoring, recording and analyses of the operating parameters for hardware components. Similarly though, an entire host of problems can be prevented in certain cases even when the cause is something outside the system itself. This not only enables the user to estimate time of failure but in many cases it enables them to prolong the lifetime of the components by ensuring normal functioning parameters.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for determining hardware life expectancy, the method comprising:
collecting data from a hardware component in a first computational device;
creating a quantitative value representing the status of the hardware component;
determining a lifetime of the hardware component; and
providing an alert to the first computational device based on the determined lifetime of the hardware component.

2. The method of claim 1, wherein creating a quantitative value representing the status of the hardware component comprises performing a linear fit to a plurality of sampling points.

3. The method of claim 1, wherein creating a quantitative value representing the status of the hardware component comprises performing a non-linear fit to a plurality of sampling points.

4. The method of claim 1, wherein creating a quantitative value representing the status of the hardware component comprises integrating a parameter value over an extended period of time.

5. The method of claim 1, further comprising receiving a user request for status of the hardware component.

6. The method of claim 1, further comprising providing a status of the hardware component to a second computational device.

7. The method of claim 1, further comprising performing a preventive operation on the hardware component.

8. The method of claim 7, wherein the preventive operation on the hardware component comprises replacing the hardware component.

9. The method of claim 1, wherein the hardware component is a redundancy unit in a redundancy system, the method further comprising balancing a load in each of a plurality of redundancy units based on the lifetime of the hardware component.

10. The method of claim 1, wherein the hardware component is a backup unit in a backup system configured to dynamically store information, the method further comprising determining a backup frequency for the backup system based on the lifetime of the hardware component.

11. A system comprising a memory circuit storing commands, and a processor circuit configured to execute the commands stored in the memory circuit, causing the system to perform a method comprising:
collecting data from a hardware component in a first computational device;
creating a quantitative value representing a status of the hardware component;
determining a lifetime of the hardware component; and
performing a preventive operation on the hardware component.

12. The system of claim 11, further comprising a plurality of redundancy units including the hardware component in a server computer configured to store large amounts of information for long periods of time, the system configured to balance a load for each of the plurality of redundancy units.

13. The system of claim 11, wherein the system is a backup system configured to dynamically store information from a plurality of computers in a local area network (LAN).

14. A non-transitory computer-readable medium storing commands which, when executed by a processor circuit in a computer, cause the computer to perform a method for managing a plurality of hardware devices according to a hardware life expectancy, the method comprising:
accessing an application programming interface (API) to obtain status information of a hardware component in a computational device;
balancing a load for a plurality of redundancy units in a redundancy system; and
determining a backup frequency for a plurality of backup units in a backup system.

15. The non-transitory computer-readable medium of claim 14, wherein balancing a load for a plurality of redundancy units comprises reducing the load on a first redundancy unit when a lifetime expectancy of the redundancy unit is lower than a lifetime expectancy on a second redundancy unit.

16. The non-transitory computer-readable medium of claim 14, wherein balancing a load for a plurality of redundancy units comprises reducing the load on a redundancy unit when the lifetime expectancy of the redundancy unit is lower than a mean lifetime expectancy.

17. The non-transitory computer-readable medium of claim 14, wherein determining a backup frequency in a backup system comprises increasing the backup frequency in a first backup unit when a lifetime expectancy of the first backup unit is lower than a lifetime expectancy of a second backup unit.

18. The non-transitory computer-readable medium of claim 14, wherein accessing an API to obtain status information comprises obtaining an expected end of life for each of the plurality of redundancy units.

19. The non-transitory computer-readable medium of claim 14, wherein the commands executed by the processor further cause the computer to provide through a network a parameter value and a time value, the parameter associated with the operation of at least one of the redundancy units.

20. The non-transitory computer-readable medium of claim 19, wherein the parameter value includes a rotational speed of a fan configured to cool the at least one of the redundancy units.
